(19) United States
(12) Patent Application Publication
(10) Pub. No.: US 2006/0036508 A1
(43) Pub. Date: Feb. 16, 2006

(54) System, method and apparatus for selling and purchasing items

(76) Inventor: Yusef Miles Fry, San Diego, CA (US)

Correspondence Address: Erik M. Vieira;Vieira & Associates, Post Office Box 13593, La Jolla, CA, 92039, US

(21) Appl. No.: 11/203,868

(22) Filed: Aug. 9, 2005

Related U.S. Application Data
(60) Provisional application No. 60/600,189, filed on Aug. 9, 2004.

(51) Int. Cl. G06Q 30/00

(52) U.S. Cl. 705/26

(57) ABSTRACT

A system, method and apparatus are disclosed to optimize selling and purchasing of items. The system and method optimizes a seller's profit margin, while simultaneously minimizing cost to a purchaser to a fraction of the cost of the item. In some embodiments of the present teachings, a seller may make several hundreds of percent of profit on an item sold, while a purchaser will simultaneously obtain the item at a small fraction of the wholesale cost of the item. In one exemplary embodiment, the present teachings are rendered on an internet website, having a database structure operatively coupled thereto.

### CROSS-REFERENCE TO RELATED APPLICATION AND CLAIM OF PRIORITY

This application claims the benefit of priority under 35 U.S.C. § 119(e) to U.S. Provisional Application No. 60/600,189, filed Aug. 9, 2004, entitled “SYSTEM, METHOD, AND ARTICLE OF MANUFACTURE FOR SELLING AND PURCHASING ITEMS.” (ATTY DOCKET NO. ELO-001-PROV). The U.S. provisional application described above is hereby incorporated by reference herein, in its entirety, as if set forth in full.

### BACKGROUND

1. Field

This disclosure relates to systems, methods, and apparatuses for purchasing and selling goods and/or services between a purchaser and a seller using a venue and more specifically, for optimizing profit and cost margins associated therewith.

2. Related Art

Various systems and methods for selling and purchasing goods and services have been proposed and implemented. One disadvantage of prior art methods for conducting transactions for goods and services is the growing demand for consumers to be able to browse merchandise and shop for items over a computer network. That is, consumers are increasingly shopping through “virtual” storefronts offered over internet networks, such as the Internet. Such virtual shopping saves a consumer time by not requiring the consumer to travel to an actual store to browse and stand in line to purchase good or services.

As computational systems have developed, the manner in which goods and services are sold has evolved. Indeed, it is hardly necessary for a consumer to leave the comfort of their own home to purchase groceries, vehicles, maid services, and just about any other good or service imaginable, largely as a result of internet computational networks, such as the Internet. Grocery stores have “websites”, whereby a consumer can select food products for purchase. E-bay® has an “on-line” purchasing system, whereby consumers can bid on goods for sale in an auction-like manner. Automotive dealers have websites whereby consumers can select precisely what sort of vehicle they desire, without needing to leave the privacy of their own home. The list of goods and/or services available for purchase on computational internet networks is extensive and growing.

One disadvantage associated with prior art selling is a fixed profit associated with a seller's profit margin. For example, when a grocery store sells its goods, it will have a fixed profit margin for each product, based in part on the wholesale price of the good, and based in part on the overhead of the seller. In another example, when bidders bid on a good for sale on E-bay®, although a seller may increase the profit margin slightly more than a grocery store's fixed profit margin (due to a difference in overhead cost), there are still rules that restrict the seller's profit margin.

Another disadvantage associated with prior art purchasing is a fixed cost margin associated with a buyer's cost margin. That is, a cost margin for a buyer is typically closely linked to the profit margin of the seller. In many respects, a buyer's cost margin is inversely proportional to a seller's profit margin. That is, the lower the seller's profit margin, the greater the buyer's cost margin (e.g., amount saved on the purchase). A buyer has little or no control over how much he/she pays for the good or service he/she wishes to purchase, except for in some circumstances limited bargaining power. Clearly, it would be advantageous if a potential buyer of goods and/or services could have greater control over the cost margin associated with purchasing a product.

The present disclosure addresses the aforementioned limitations of the prior art solutions for buying and selling products and/or services. The present disclosure provides a system, method, and apparatus for maximizing a seller's profit margin, while simultaneously minimizing a buyer's cost margin.

### SUMMARY

A system for performing simultaneous optimization of a cost margin and a profit margin during a transactional sale of an item, wherein the profit margin to a seller of the item is profit-wise optimized and the cost margin of the item to at least one buyer pool of the item is cost-wise optimized, is disclosed.

In one embodiment, a venue is adapted for conducting the transactional sale of the item between the seller and the at least one buyer pool, wherein the venue has a venue interface associated therewith. A database structure is adapted for storing information pertaining to the transactional sale of the item, wherein the database structure is operatively coupled to the venue and wherein the database structure is further operatively coupled to the venue interface. A plurality of ticket elements, corresponding to a particular item for which the seller desires to sell and for which the at least one buyer desires to buy, having a quantity of ticket element information relating to the transactional sale of the item is provided. The ticket element has a first cost associated therewith, wherein the quantity of ticket element information is stored within the database structure. The cost associated with each ticket element is a small fraction of the wholesale cost of the item, and a buyer increases the odds of purchasing the item, by increasing the number of ticket elements the buyer purchases.

At a first predetermined time, the at least one buyer pool commences purchasing at least one of the plurality of ticket elements through the venue interface. The database structure stores information corresponding and associated with the purchasing of the at least one of the plurality of ticket elements. A ticket pool, comprises a quantity of information pertaining to the plurality of ticket elements purchased by the at least one buyer pool. The ticket pool information is stored within the database structure. An event occurs, wherein the purchasing of ticket elements is final and at least one ticket element is selected from the ticket pool and the at least one winner receives the item.

In one embodiment, the present system and method is rendered on an internet website (such as on the Internet). In this embodiment, a potential purchaser may view an item offered by a seller for inspection on the website. A potential purchaser views the item offered on the website and may purchase one or more ticket(s) for the opportunity to purchase the item. Each ticket has a unique identifier to connect the purchaser to the ticket.

In one embodiment, the odds of winning may be scaled by increasing a ticket's purchase price, while simultaneously reducing a total number of tickets sold. By reducing the number of tickets sold for a particular item, overall odds of a particular ticket purchaser increases proportionately.

### BRIEF DESCRIPTION OF THE DRAWINGS

Embodiments of the present invention will be more readily understood by reference to the following figures, in which like reference numbers and designations indicate like elements.

FIG. 1 illustrates a contest system according to the present disclosure.

FIG. 2 illustrates a registration process for an aspect of one embodiment of the present disclosure.

FIG. 3 illustrates a log in process for an aspect of one embodiment of the present disclosure.

FIG. 4 illustrates a product selection and payment group for an aspect of one embodiment of the present disclosure.

FIG. 5 illustrates a winner selection process for an aspect of one embodiment of the present disclosure.

FIG. 6 illustrates a credit/reward point process for an aspect of one embodiment of the present disclosure.

### DETAILED DESCRIPTION

Overview

The present teachings disclose a system, method, and apparatus for purchasing and selling goods and/or services. Initially, a seller displays goods and/or services for which purchasing individuals buys tickets. A plurality of purchasers buys tickets at a fractional cost of the goods and/or services desired. Each ticket has a unique identifier associated therewith. At a first predetermined time, ticket sales commence. At a second predetermined time, ticket sales are halted and a “contest” commences. The “contest” functions to randomly choose at least one ticket from the pool of tickets purchased for each respective good and/or service. In one illustrative exemplary embodiment, the present disclosure is rendered in an Internet website. In this embodiment, bidders can view a good and/or services image and description and determine whether to purchase a ticket.

As used herein, the term, “contest” is generally meant to refer to a useful system and method whereby a potential purchaser buys a ticket, which is sold a predetermined price at a fraction of the cost of an item for sale, and then after ticket sales terminate, a ticket is selected from a pool of sold tickets and at least one ticket is drawn. The at least one ticket drawn from the pool of tickets is a “winning” ticket(s), thereby giving the purchaser of the ticket a right to claim the item if that ticket is selected from the pool of tickets. Each ticket sold has a unique identification code affixed thereto, to trace the ticket to the purchaser of the ticket.

As used herein, the term “seller” is generally meant to refer to any entity (e.g., person, corporation) offering a good or service into a “contest”. It will be appreciated that a seller is literally any type of entity having the capacity to offer goods and/or services into the contest. Such sellers include, without limitation resellers, retail sellers, after-market sellers, antique sellers, private persons, corporations, and distributors.

As used herein, the term “purchaser” or “buyer” refers to an entity (e.g. person, corporation) buying a ticket for the purpose of participating in a contest for an item. In one embodiment of the present teachings, the system and method includes a single purchaser having the ability to purchase at least one ticket for an item.

The term “item” refers broadly to any tangible or intangible good and/or service for which a seller desires to offer into a contest (e.g., big screen television, car, computer, boat, house, land, business). It will be appreciated that an item can be new or used. In one embodiment of the present teachings, retail distributors may optionally offer products for sale to purchasers in the contest. In some embodiments, the item can be intangible (e.g., concert/movie tickets, cruises, games, vouchers, therapies, technologies).

As used herein, the term “commerce” is meant generally to refer to the purchase and sale of items for valuable consideration. Commerce can mean, inter alia, interstate commerce, intrastate commerce, electronic commerce (“e-commerce”), or the purchase and sale of items to and from foreign countries. In some embodiments of the present disclosure, strict rules may be established limit commerce to specified geographical boundaries.

As used herein, the term “ticket” is generally meant to include tangible and/or intangible tickets. In one embodiment, a purchaser would receive a paper ticket, having a unique identification number, such as for example a bar code. In another embodiment, a purchaser would receive an electronic ticket (intangible), having a unique identification number associated therewith. In one variation of the intangible ticket embodiment, a purchaser will obtain a secured confirmation of the purchased ticket.

As used herein, the term “digital processor” or “microprocessor” is meant generally to include all types of digital processing apparatuses including, without limitation, digital signal processors (DSPs), reduced instruction set computers (RISC), general-purpose (CISC) processors, microprocessors, and application-specific integrated circuits (ASICs). Such digital processors may be contained on a single unitary IC die, or distributed across multiple components. Exemplary DSPs include, for example, the Motorola MSC-8101/8102 “DSP farms”, the Texas Instruments TMS320C6x, or Lucent (Agere) DSP16000 series.

Rules Based Contest

The present teachings disclose a system and method for a rules based contest for the purchase and sale of goods and/or services. Initially, a potential seller of a good or service displays information regarding the good or service for examination by potential purchasers. In some embodiments of the present teachings, such information may be displayed physically, such as for example on television, a newspaper, magazine or other tangible medium. In another embodiment of the present teachings, such information is displayed through a website on an internet network, such as for example the Internet (e.g., World Wide Web).

In one embodiment, the system and method increases a seller's profit margin substantially, while simultaneously giving a pool of purchasers the chance to obtain an item at a fraction of the cost of the item. In one exemplary embodiment, a seller may offer an item valued at $100.00 into the contest, wherein tickets may be purchased for $1.00 each. If a thousand people each buy one ticket, the seller will obtain $1000.00, and the purchaser will obtain an item valued at $100.00 for the price of $1.00. Hence, the seller will have received an optimized profit margin over the sale price of $900, and the purchaser will have obtained an item valued at $100 for $1, thereby receiving an optimized cost-margin. Note that the purchaser (buyer) can improve the odds of actually receiving the item by increasing the number of tickets (e.g., ticket elements) purchased, hence increasing the possibility of having at least one of that purchaser's tickets drawn when the contest commences.

At a first predetermined time, tickets for the item go on sale for potential purchasers to buy. In one embodiment of the present disclosure, a single purchaser may buy only a single ticket for the subsequent contest of the item. In another embodiment, a purchaser may buy a predetermined limit on the number of tickets. Such a predetermined limit may apply to a particular item, or to a particular purchaser. In yet another embodiment of the present disclosure, a purchaser may buy as many tickets as desired, until ticket sales close.

At a second predetermined time (event), ticket sales are terminated. Ticket sales can be terminated at a time wherein a certain total value of tickets sold is reached, or at a specific time. In this way, a seller can select a target profit margin for the item sought to be sold. Each ticket purchased during the course of the ticket sales for a particular item have a uniquely identifying tag, which is issued by a contest official and readily capable of authentication. That is, to prevent fraud, each ticket is “stamped” with a unique code. In one embodiment of the present teachings, the “stamp” can be a number, or combination of numbers or coding printed on a tangible (or intangible) ticket. In another embodiment of the disclosure, the ticket can be electronically stamped. In this embodiment, the stamp can be an encrypted code, bar code, optical, or other “stamp” capable of electronic authentication. In yet another embodiment of the present teachings, a purchaser may create or use their own numbering/coding system. In this embodiment, safeguards will be implemented to assure no redundancy of the numbering/coding of tickets.

In one embodiment, the second predetermined time comprises an event. In one exemplary embodiment, the event is a target profit margin. That is, a seller may select a profit percentage as a target for the end of ticket sales. Hence, once enough tickets have been sold to achieve the seller's selected profit margin, the contest begins. In other embodiments, a profit margin is not set, hence a seller has unlimited profit potential as more tickets are sold to purchasers.

Subsequent to the termination of ticket sales, the tickets are pooled together in a storage location, such as for example a secure (e.g., fire-walled) database structure. In one embodiment, a single ticket is selected from the pool of tickets and a single winner is selected to whom the item is then awarded. In another embodiment, there may be multiple ones of a particular item (e.g., three flat screen televisions), from which a respective multiple number of tickets will be drawn to determine a winner. In one illustrative example of this embodiment, if a seller offers three flat screen televisions into the contest, then three tickets will be drawn from the pool of tickets. If a ticket is drawn, the purchaser of the ticket “wins” the item and will be awarded the item.

In some embodiments, whole sale and/or company direct merchants may contest items in the aforementioned fashion. In other embodiments, charitable donations can be the subject of the contest. Alternate embodiments include providing a venue for authorized entities to sell their items in the contest, as disclosed herein, and providing a percentage of profits to the venue owners as a quid pro quo for usage of such a venue interface. It will be appreciated that in one embodiment, the venue will be a website for authorized entities to sell their products via the novel contest system and method of the present teachings, wherein the seller will provide the website proprietor a percentage of profits made from items sold through the venue, or at a price. In some embodiments, the venue may be a stage or physical platform (similar to an auction), whereby a potential purchaser may view an item, and then optionally purchase a ticket for a subsequent contest on the item.

In one embodiment, a kiosk-type structure may be employed as a venue for purchasing tickets for an item. Such kiosks may, in one embodiment, be found in a store. The kiosk may provide a computer terminal for a purchaser to purchase a ticket and view an item. Moreover, in one embodiment, the purchaser may view the item both on the computer screen and within the store itself.

In one embodiment of the present disclosure, a seller of an item can control a profit margin of the item for sale. By offering the item into a contest for potential purchasers to buy tickets for the chance to win the item, the seller can control the profit margin of the sale of the item by controlling when the sale of tickets ceases. The longer the amount of time the seller allows ticket sales to extend, the more tickets can be sold, therefore the higher the profit margin to the seller. In one variation of this embodiment, a purchaser of one or more tickets can increase the odds of winning by purchasing more tickets for the contest. As such, that purchaser has an increased chance of winning the item. If the purchaser wins the item, they have effectively controlled their cost margin, because the item will still have been purchased for a fraction of the total cost of the item.

In one embodiment, a seller of an item may desire to promote a new product, or limited product, in the market place and offer the item into a contest. By placing a new product into the contest, the seller is increasing public exposure of the item. Also, if a seller of items is having difficulty selling an item, the seller may enter the item into a contest to improve the movement of the seller's supply of that item.

In yet another variation of the present teachings, the system, method and apparatus may be used to promote not-for-profit entities. As such, charitable agencies may increase charitable contributions to their agency using the disclosed method, system and apparatus.

In one embodiment, real property may be entered into a contest. In this embodiment, a seller increases a profit margin, while a purchaser, who wins the contest, purchases the real property at a fraction of the cost of the property.

In some embodiments, the amount of profit will be predetermined. That is, a seller, or affiliate, will determine a desired profit margin prior to offering the item into the contest for purchasers to buy tickets for the item. Once the profit margin is realized during the course of the contest, the contest ends and at least one ticket is selected from a pool of tickets, to determine a winner(s) of the item.

The best-known computer network in use today is the Internet. When a network user begins a communication session over the Internet, the user can request data files from an Internet-connected computer called a file server or website server. The file server provides data files, typically comprising website pages, that are requested by the user. The web pages are typically written in a type of programming code called hypertext mark-up language (html), and can be viewed or displayed through a graphical user interface (GUI) program. The network connections and collection of html files are commonly referred to as the “World Wide Web” and the GUI program to view the files is called a web browser. A collection of related files under a common Internet network domain location is commonly referred to as a website.

The Internet is being used more and more often for commercial purposes. Thus, websites have become an important means for businesses and individuals to disseminate new product and service information, public relations news, advertising, and even to transact business by receiving orders and payments over the Internet.

As with most forms of advertising, a goal of providing a website is to have a large number of visitors to the website to view the commercial presentation. As a result, various software programs and monitoring services have been developed to track such file requests, which are generally referred to as web traffic.

In one embodiment of the present disclosure, the method is implemented in a website. In this embodiment, potential purchasers of items have the ability to use search engines, rendered in the website, to look for a particular item for which they desire to purchase a ticket. The search engine will provide a user with options to view descriptions of a particular item, such as for example a picture or written description.

Once a potential purchaser desires to bid on an item for the contest, the purchaser buys a ticket. In one embodiment, the purchaser may buy a ticket directly over the website (e.g., with a credit card), or other methods of buying tickets, such as obtaining a voucher over the website for later mailing of a payment (e.g., check, money order). The ticket will have an electronically authenticated numerical coding to verify the purchaser.

After the close of ticket sales, a contest commences and at least one ticket is drawn from the pool of tickets. If the ticket is validly authenticated, the purchaser corresponding to the ticket wins the item.

In one exemplary embodiment of the present teachings rendered on a website, a potential purchaser may download at least a portion of a database from a server, corresponding to information relevant to an item of interest to the potential purchaser. In one aspect of this embodiment, the downloaded portion of the database may optionally be iteratively updated, either automatically or manually, to provide the potential purchaser with current information relevant to the item of interest.

In some embodiments, sellers may structure the fractional cost of a ticket to optimize profit margin. In one exemplary embodiment, a seller can realize a profit exceeding the actual cost of the item. In one example, a seller may offer a microwave oven, valued at $150.00 into the contest. If the ticket price is set at some fraction of the total cost of the microwave, such as $6.00, and one hundred tickets are sold, then the item will have “sold” for $600.00.

Alternate embodiments include implementing a “point system” for purchasers of tickets who have not “won” anything in a contest, that is, for purchasers whose tickets have not been drawn for a particular item for which they purchased the ticket. In this point system, a purchaser will accrue points toward participating in future contests. In effect, this point system gives a purchaser another “chance” to win in another contest. In one example, if a purchaser bought a $20 ticket for a contest, but did not win the contest, the purchaser may be awarded a $20 credit toward a future contest. In one variation of this embodiment, a fraction of the original ticket cost may be awarded to the purchaser. That is, if a purchaser bought a $20 ticket for an item, but did not win the item, a $10 credit may be awarded to the purchaser toward a future contest.

In one embodiment, the contest may be subscriber based. Subscribers may participate on a monthly subscription basis (e.g., $4.95/month). The monthly amount paid for the subscription is entered into a database structure that will include their information relevant to tracing ticket purchases to a particular subscriber. In one embodiment, a subscriber may collect points in a point system similar to frequent flier miles for an airline.

In one embodiment, the methods of the present disclosure can be rendered in a network. The network may operate as a client/server type environment, using a variety of logical and/or physical connections. In one aspect of this embodiment, a server receives requests for tickets from client-based peripheral. It will be appreciate by that a client-based peripheral can be broadly defined as any electronic device capable of connecting to the network in a secure manner (e.g., computer, television, phone, wristwatch, personal digital assistant, kiosk, pager, satellite, etc.). The client receives a request to buy a ticket from a purchaser, modulates the data, and transmits the data in a communications channel (e.g., air, coaxial cable, or fiber optic cable). At the server, a receiver demodulates the transmitted data and processes the request, assigning the purchaser a unique identification code associated with the ticket.

It will be appreciated that the computerized rendering of the present teachings employs, inter alia, a memory, a digital or analog processor, bus, and a communications channel. In this rendering of the present teachings, local area networks (LANs) or wide area networks (WANs) may be implemented. Such networking environments are commonplace in offices, enterprise-wide computer networks, intranets, internets and the Internet.

In one embodiment, wherein the present teachings are rendered in an internet website, potential purchasers are guests on the internet website. In this embodiment, the guests are allowed to view a home page of the internet website and associated links to other websites. Guests are allowed to view on-line databases, which have information regarding items. There is no commitment required by the guest to purchase a ticket. Hence, a guest may view items for which the guest may desire to purchase a ticket.

In one embodiment, when a guest desires to purchase a ticket for a contest on a particular item, the guest registers on the internet website as a registered user. Once the guest has become a registered user, the homepage, and associated websites, function as a transactional venue, through which the registered user may purchase one or more tickets for different items on the website.

In one embodiment, there are at least three different categories of registered members, users, affiliates, and merchants. Registered members are allowed to log onto an official contest website and participate in one or more contests. A user registers on the official contest website and is allowed to browse different items and purchases tickets for a contest on a particular item. Registered affiliates are allowed to participate in contests. In one embodiment, affiliates may direct guests to the official contest website. In this embodiment, registered affiliates also may optionally receive benefits from the official contest website for guests the registered affiliate directs to the official contest website. Merchants who desire to sell items through the official contest website will also be registered members, and may place items for sale in the contest on the website.

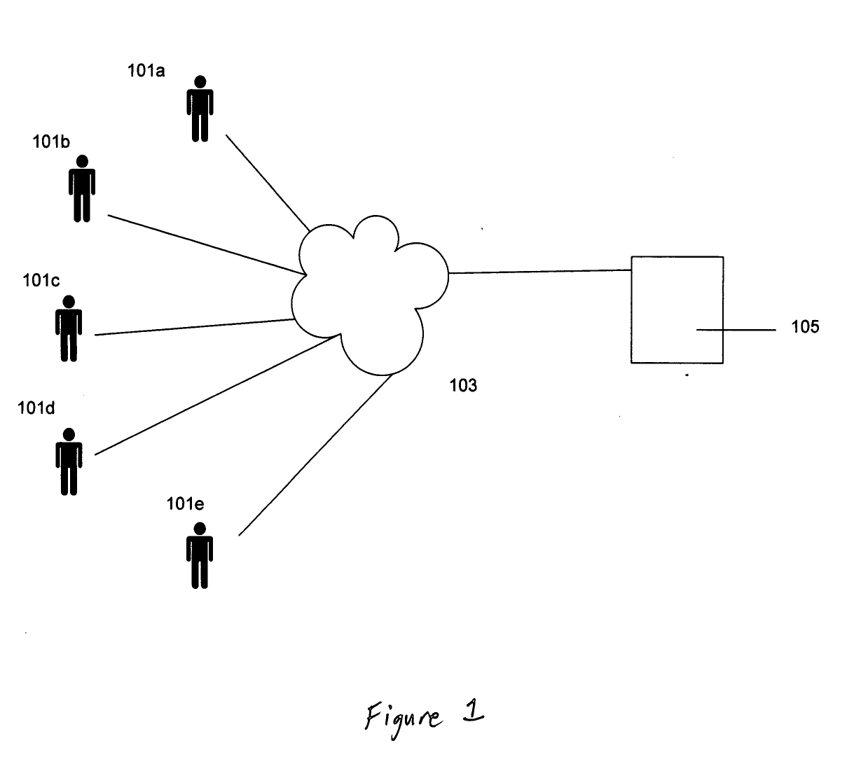

Referring now FIG. 1, a system according to the present disclosure is illustrated. In one embodiment, contest participants 101a-e are systematically coordinated together for contest purposes via a network 103. Contest participants 101a-e comprise users, affiliates, and merchants. A user is a person who desires to enter into a contest for a particular item. The user may browse network 103 resources to determine which item the user may desire to compete for in a corresponding and associated contest. An affiliate may participate in a contest at different levels. An affiliate may participate in a contest, or simply refer users to a contest web page. Merchants provide items for which users and affiliates may compete for in a contest. The network 103 functions to organize the contest for an item 105. That is, the network 103 organizes user information, validation and registration, as well as storing such information. As will be described in greater detail below, the network 103 has many different access points for different contest participants 101a-e, and various storage databases and scripts for coordinating and organizing a contest for the item 105.

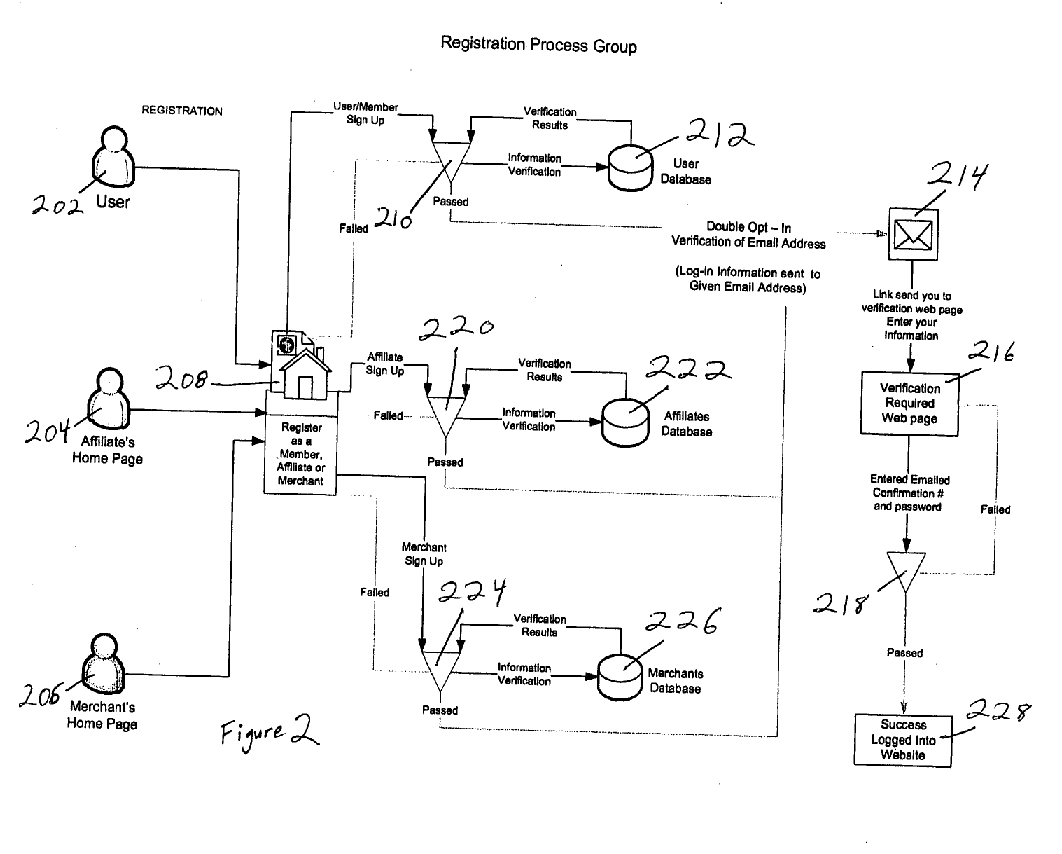

Referring now to FIG. 2, a registration process is illustrated. A user 202, affiliate 204, and/or a merchant 206 may register at a webpage interface 208, as a member of a contest website. During the registration process, a different routing registration verification script is employed to complete the registration process. In one exemplary embodiment, a user 202 registers through a user verification process (user verification script) 210. An affiliate 204 registers through an affiliate verification process (affiliate verification script) 220. A merchant registers through a merchant verification process (merchant verification script) 224. Hence, a member is routed through a different registration process, depending on what kind of function the member will perform on the website.

Each registration process 210, 220, and 224 verifies that certain information required for each respective registration is accurate and correct. When each registration process is completed and verified, a member file is created for that particular member in a respective database. That is, a user 202 passing a user verification process 210 will have a member file created in a user database 212. An affiliate 204 passing an affiliate verification process 220 will have a member file created in an affiliate database 222. A merchant 206 passing a merchant verification process 224 will have a member file created in a merchant database 226. Once a member has passed a respective registration process, and a file has been created in the proper database, notification of completion of the verification process may optionally be sent to the registered member (e.g., by email). Each respective database 212, 222, 226 will store the respective member's personal information entered during the registration process.

In one embodiment, an email 214 is sent to the registered member to provide a double opt-in form of verification. In this embodiment, the registered member receives the email 214, and responds to the email, thereby confirming all pertinent information to verify the initial registration. In this embodiment, the email 214 contains a website link, directing the recipient to a verification web page 216, whereat all the verification information is entered and submitted to a validation script 218. The validation script 218 functions to compare information provided by the verification web page 216 and information stored in the member's respective database. If the information in the respective member's database is consistent with the information provided by the verification web page 216, then verification is considered to have “passed” and a member will be directed to an appropriate website. That is, if a user 202 “passed”, then the user 202 will be directed to a user website for browsing items and purchasing tickets for a contest for that particular item. If an affiliate 204 “passed”, then the affiliate 204 will be directed to the appropriate affiliate website, having the appropriate associated functionality. If a merchant “passed”, then the merchant 206 will be directed to a merchant website. If a member “fails” verification, the member is redirected to the verification page 216 for further processing.

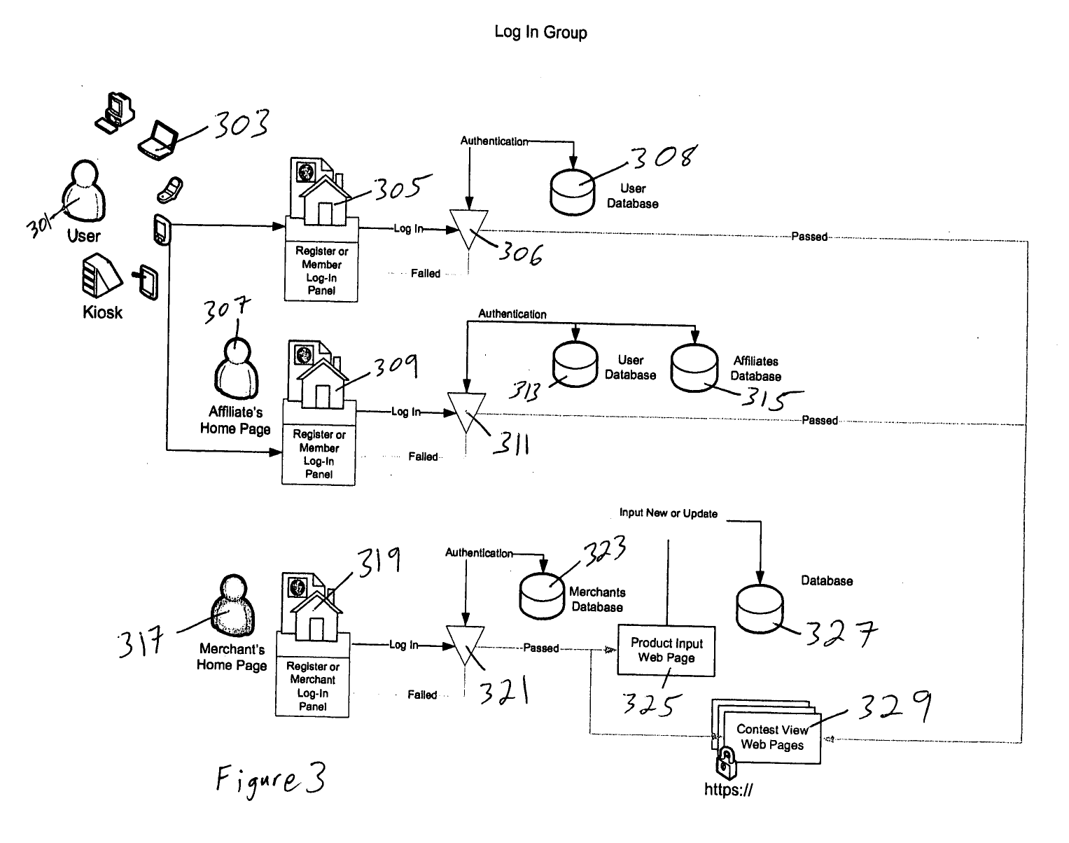

Referring now to FIG. 3, a log in process of one embodiment of the present disclosure is illustrated. A registered member may log into an appropriate website for their level of participation in a contest. That is, a user 301 will log in at a user web page 305. An affiliate 307 will log in at an affiliate web page 309. A merchant 317 will log in at a merchant web page 319. When a member 301, 307, or 317 logs in to an appropriate web page, their log in information is submitted to an appropriate validation script, 306, 311, or 321 respectively. Validation script 306, 311, and 321 function to compare information provided by the appropriate log in web page with information stored in the appropriate member database, 308, 315, and/or 323 respectively. If the compared information is approved, then the member is considered to have “passed” verification, and will be directed to a contest viewing web page 329 for viewing contest web pages. In one embodiment, a merchant 317 will have an option to access to a product input web page 325 or directed to the contest viewing web page 329. In the event that verification fails, in one embodiment, a member is redirected to an appropriate log in web page 305, 309, or 319 for an explanation of the log in error.

In one embodiment, a product input web page 325 allows a merchant 317 to enter and/or update items into a database 327. The database 327 stores item data (e.g., goods, services), which may be accessed through a product input web page 325.

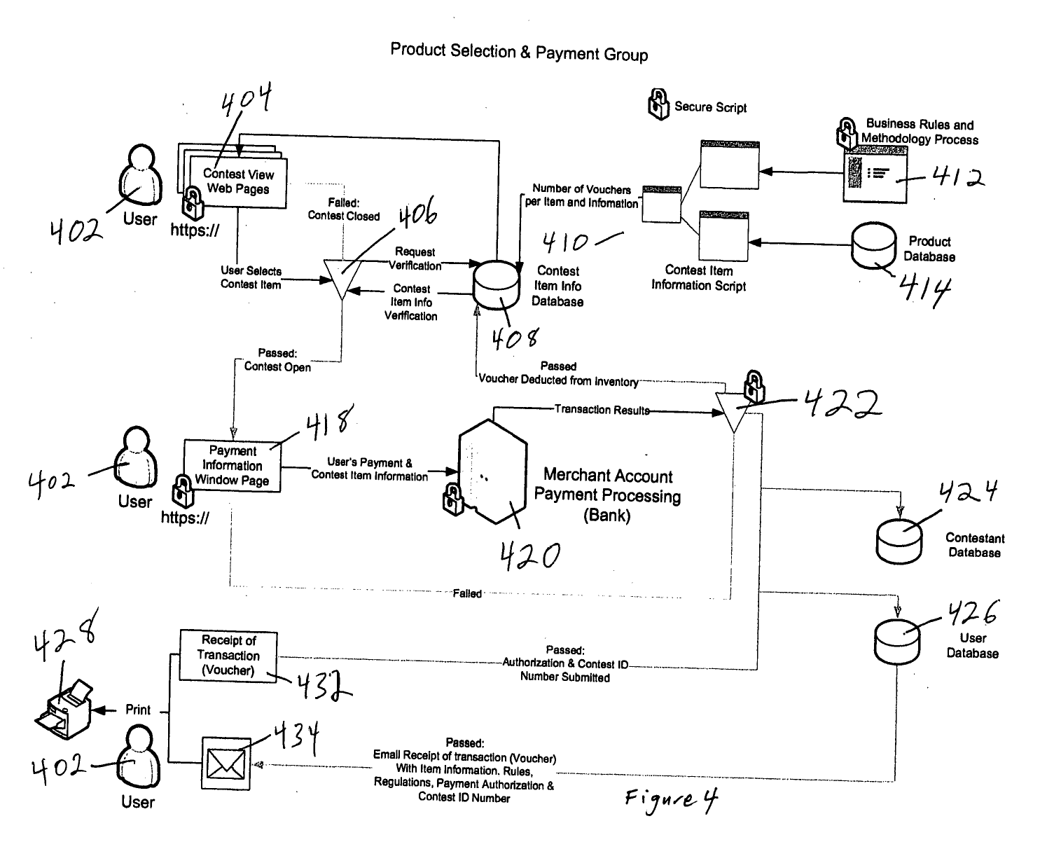

Referring now to FIG. 4, a product selection and payment process is illustrated for purchasing a ticket for an item in a contest. FIG. 4 illustrates a process of selecting an item, making a payment, issuance of voucher or ticket, and receiving a receipt. Initially, a user 402 views a contest web page 404 to browse and select a contest item. Once a contest item has been selected, a verification script 406 is generated. The verification script 406 is adapted to compare contest item information from the contest view web page 404 with information from the contest item information database 408. If the verification script 406 is compared and validated (passed), then the user 402 is directed to a payment information web page 418. If the verification script 406 is compared and not validated (failed), then the user 402 is directed to the contest view web page 404, where an optional error explanation may be provided.

In one embodiment, when the verification script 406 is compared and validated and the user 402 is directed to the payment information window page 418, payment data is entered by the user 402, and the payment data is transmitted to a merchant account payment processing 420 for payment verification. The merchant account payment processing 420 attempts to secure payment from the user 402. The results of the merchant account payment processing 420 (passed or failed) are transmitted to a payment validation script 422. The payment validation script 422 processes information provided by the merchant account payment processing 420 to produce a result and further action, depending on whether verification of the payment validation script 422 passed or failed. If verification of the payment validation script 422 passed, then a voucher is procured from the contest item information database 408 and contestant information (user information) is entered into contestant database 424. Then, the user 402 is directed to a receipt of transaction web page 432 for confirmation of validation. A user database 426 provides email 434 to the user 402 with information (e.g., voucher number, rules, regulations, payment authorization information, contest identification number) about the item for which the user 402 purchased a ticket.

If verification of the payment validation script 422 fails, then the user 402 is directed to a payment information web page 418, where the user 402 may view an explanation of reasons why verification failed.

In one embodiment, a business rules and methodology process 412 produces a desired profit margin. In one embodiment, the business rules and methodology process 412 provides a due date for a contest winner selection, which is transmitted to a contest item information script 410. A product database 414 contains contest item information, which is used throughout the network.

A contest item script 410 produces contest item information for use by the network. The contest item script 410 functions to generate vouchers, tickets, due dates for winner selection and contest item information required for a contest for a particular item. The contest item information is derived by using the profit margins for the particular contest item, business rules as provided in the business rules and methodology process 412, and the item information provided by product database 414. Contest item information is generated and transmitted to the contest item information database 408, which functions to store information for the contest item.

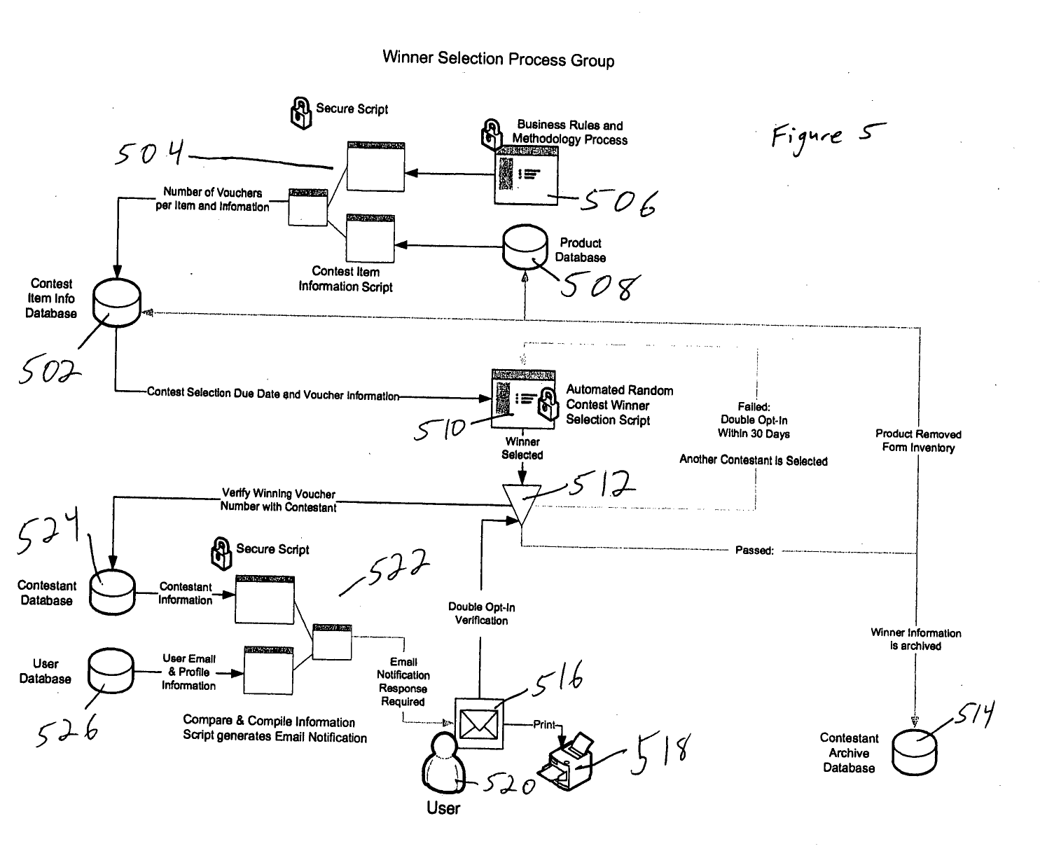

Referring now to FIG. 5, a winner selection process is illustrated. A business rules and methodology process 506 produces profit margins and due dates for a winner selection, which is transmitted to a contest item script 504. A product database 508 contains item information inputted by merchant members. The contest item script 504 is adapted to produce contest item information. The contest item script 504 generates vouchers, tickets, due date for winner selection, credit and reward points, and other contest item information necessary for conducting the contest for a particular item. This information is derived by using the profit margins required, business rules (provided by the business rule and methodology 506), and item information provided by the product database 508. Relevant contest information is then transmitted to a contest information database 502. The contest information database 502 functions to temporarily store all information for a contest item. When a contest for a particular item is finished, information regarding contestants in that particular contest is relocated by transmitting it to a contestant archive database 514. Contest selection due date and voucher information is transmitted to an automated random contest winner selection script 510. The automated random contest winner selection script 510, functions to select winner(s) from the information provided by the contest item information database 502. When a winner of a contest is selected, the information is passed to a verification script 512. In one embodiment, the verification script confirms that a winner's information is correct by double opt-in verification. When a winning voucher/ticket number is selected, contestant information is sent to a contestant information database 524 for processing and emailing double opt-in information to the winner of the contest, who receives a confirmation link 516 by email. A contestant archive database 514 stores information regarding a contest, comprising winning and non-winning contestants.

A contestant who has won the contest for a particular item receives an email having a confirmation link 516. An email notification script 522 is generated when the contestant confirms winning the item via confirmation link 516. A user 520 initiates a verification link in order to be recognized as the winner of the item. Information used to send the user 520 a double opt-in winner verification link is derived, at least in part, from contestant database 524 and user database 526. The contestant database 524 temporarily stores contestant information until a winner is selected. In one embodiment, credit/reward points are awarded to the non-winner. When a particular item contest is finished, contest information for a particular contestant is relocated by transmitting such information to contestant archive database 514. The user database 526 functions to store member (user, affiliate, merchant) information.

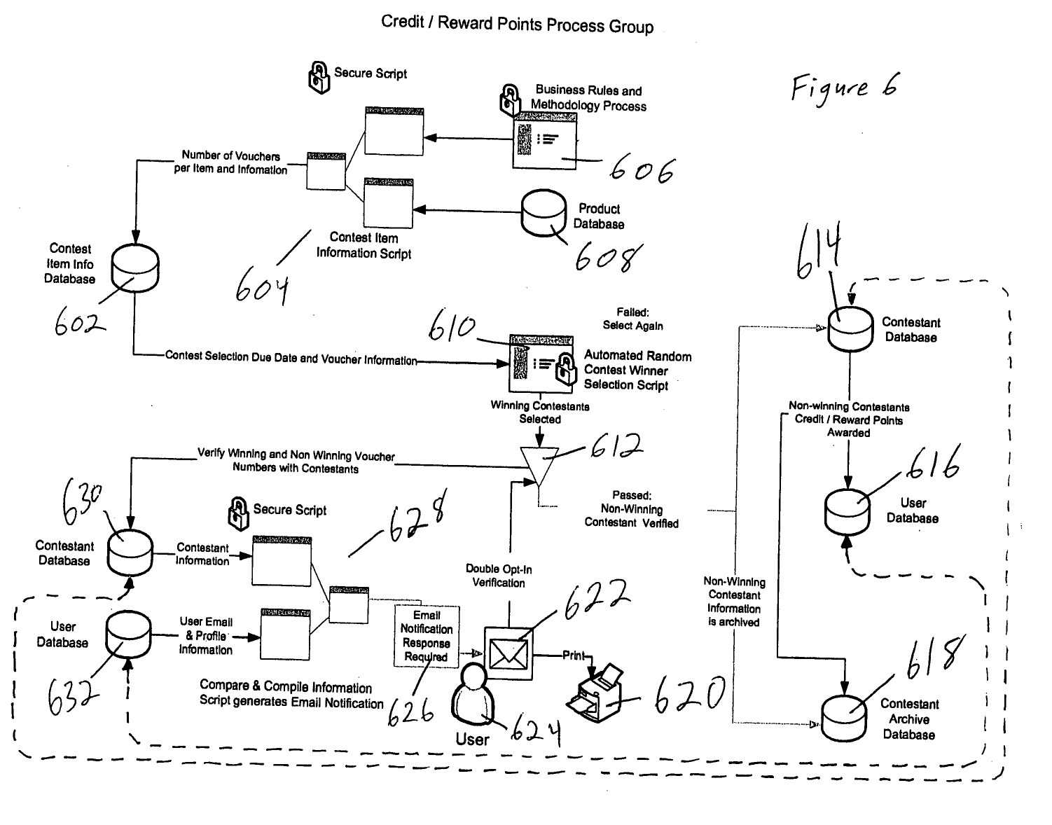

Referring now to FIG. 6, a process for awarding points for credits and/or rewards is illustrated. Business rules and methodology process 606 produces profit margins and due dates for winner selection, which is then transmitted to a contest item script 604. A product database 608 contains information inputted by merchants regarding items entered into a contest. The contest item script 604 produces contest item information, utilizing the business rules and methodology 606 and the product database 608. The contest item script 604 generates vouchers and/or tickets for a contest, a due date for winner selection, credit and reward points and contest item information needed for the contest over a particular item. Data generated is transmitted to the contest item information database 602. The contest item database 602 stores information for a particular contest item. Contest selection due date, credit and/or reward points and voucher information is transmitted to an automated random contest winner selection script 610. The automated random contest winner selection script 610 selects winners from the information provided by the contest item information database 602. Once a winner is selected, the non-winners' information is passed to a non-winner verification script 612. The non-winner verification script 612 verifies non-winner information is correct by double opt-in verification. Non-winning credit and/or reward points are awarded, and contestant information is sent to contestant database 630 for processing and an email 622 containing double opt-in verification information is sent to non-winners. Non-winning contestants are removed from the contestant database 614. The contestant database 614 temporarily stores contestant information until a winner is selected and credit and/or reward points are awarded to non-winners. Credits and/or rewards are awarded to non-winning contestants and such information is transmitted to a user database 616 for storage. Non-winning contestant information is transmitted to and archived in a contestant archive database 618. An email notification script 626 generates emails to non-winners email address on file.

When used in a LAN networking environment, the client system is connected to the local network through a network interface or adapter physical or virtual. When used in a WAN networking environment, the client system typically includes a modem, or is connected to a communications server on the LAN, or has other means for establishing communications over the WAN, such as the Internet. The modem, which may be internal or external or virtual, is connected to the system bus via a port interface. In a networked environment, program modules depicted relative to the client system, or portions thereof, may be stored in a remote memory storage device. It will be appreciated that the network connections described herein are exemplary and other means of establishing a communications link between the computers (e.g., client, server) may be used.

In accordance with the practices of persons skilled in the art of computer programming, some embodiments of the present teachings have been described with reference to acts and symbolic representations of operations that are performed by a computer, such as the client system or remote computer. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, CD-ROM) to thereby reconfigure or otherwise alter the computer system's operation, as well as other processing of signals. The memory locations where such data bits are maintained are physical locations that have particular electrical, magnetic, or optical properties corresponding to the data bits. What has been described above are preferred aspects of the present teachings. It is, of course, not possible to describe every conceivable combination of components or methodologies for purposes of describing the present teachings, but one of ordinary skill in the art will recognize that many further combinations and permutations of the present disclosure are possible. Accordingly, the present teachings is intended to embrace all such alterations, combinations, modifications and variations that fall within the spirit and scope of the appended claims. Furthermore, to the extent that the term “includes” is used in either the detailed, description or the claims, such term is intended to be inclusive in a manner similar to the term “comprising.”

One of the preferred implementations of the present teachings is in an application program, (i.e. a browser program made up of programming steps or instructions resident in RAM) of a Web receiving station during various Web operations. Until required by the computer system, the program instructions may be stored in another readable medium, (e.g. in disk drive, or in a removable memory such as an optical disk for use in a CD ROM computer input, or in a floppy disk for use in a floppy disk drive computer input, not limited to fire wire ports, USB and future and primitive inventions, even if it is inscribed on a rock). Further, the program instructions may be stored in the memory of another computer prior to use in the system of the present disclosure and transmitted over a LAN or a WAN, such as the Web itself, when required by the user of the present disclosure. One skilled in the art should appreciate that the processes controlling the present disclosure are capable of being distributed in the form of computer readable media of a variety of forms.

What is claimed is:

1. A system for performing simultaneous optimization of a cost margin and a profit margin during a transactional sale of an item, wherein the profit margin to a seller of the item is profit-wise optimized and the cost margin of the item to at least one buyer pool of the item is cost-wise optimized, comprising:
(a) a venue adapted for conducting the transactional sale of the item between the seller and the at least one buyer pool, wherein the venue has a venue interface associated therewith;
(b) a database structure adapted for storing information pertaining to the transactional sale of the item, wherein the database structure is operatively coupled to the venue and wherein the database structure is further operatively coupled to the venue interface;
(c) a plurality of ticket elements, corresponding to a particular item for which the seller desires to sell and for which the at least one buyer desires to buy, having a quantity of ticket element information relating to the transactional sale of the item, wherein the ticket element has a first cost associated therewith, and wherein the quantity of ticket element information is stored within the database structure;
(d) a first predetermined time, wherein the at least one buyer pool commences purchasing at least one of the plurality of ticket elements through the venue interface, wherein the database structure stores information corresponding and associated with the purchasing of the at least one of the plurality of ticket elements;
(e) a ticket pool, comprising a quantity of information pertaining to the plurality of ticket elements purchased by the at least one buyer pool, wherein the ticket pool information is stored within the database structure;
(f) an event, wherein the purchasing of ticket elements is final and at least one ticket element is selected from the ticket pool, wherein the at least one winner receives the item.

2. The system of claim 1, wherein the venue comprises a website, operatively associated with a computer network and the venue interface comprises at least one webpage.

3. The system of claim 2, wherein database structure further comprises a computer database structure operatively coupled to the website and the webpage.

4. The system of claim 3, wherein the plurality of ticket elements comprises a ticket encoded with information associated with and corresponding to the item and the identity of the buyer.

5. The system of claim 4, wherein the event is a second predetermined time to finalize ticket purchasing.

6. The system of claim 4, wherein the event is a predetermined profit margin, selected to correspond to a profit created by the purchasing of ticket elements by the at least one buyer pool.

7. A method for conducting a transaction for a sale of an item, comprising:
(a) a venue means, adapted for conducting the transactional sale of the item between the seller and the at least one buyer pool, wherein the venue means has a venue interface means operatively associated therewith;
(b) a database structure means, responsive to the venue means, adapted for storing information pertaining to the transactional sale of the item, wherein the database structure means is operatively coupled to the venue means and wherein the database structure means is further operatively coupled to the venue interface means;
(c) a plurality of ticket element means, responsive to the database structure means, corresponding to a particular item for which the seller desires to sell and for which the at least one buyer desires to buy, having a quantity of ticket element information relating to the transactional sale of the item, wherein the plurality of ticket element means has a first cost associated therewith, and wherein the quantity of ticket element information is stored within the database structure means;
(d) a first predetermined time, wherein the at least one buyer pool commences purchasing at least one of the plurality of ticket element means through; the venue interface means, wherein the database structure means stores information corresponding and associated with the purchasing of the at least one of the plurality of ticket element means;
(e) a ticket pool means, responsive to the database structure means, comprising a quantity of information pertaining to the plurality of ticket element means purchased by the at least one buyer pool, wherein the ticket pool information is stored within the database structure means;
(f) an event means, responsive to the venue means, wherein the purchasing of ticket element means is final and at least one ticket element is selected from the ticket pool means, wherein the at least one winner receives the item.

8. The method of claim 7, wherein the venue means comprises a website operatively associated with a computer network.

9. The method of claim 8, wherein the database structure means further comprises a computer database structure operatively coupled to the website.

10. An apparatus for optimizing a sale profit to a seller of an item and minimizing a cost of the item to a purchaser, the system comprising:
a. a seller of the item making an offering of the item at a venue, whereat a potential purchaser can study information pertaining to the item and purchase a ticket at a first predetermined time, the ticket having a unique identifying code associated therewith;
b. at a second predetermined time, ticket sales terminating and a predetermined number of tickets selected from a pool of tickets, whereby the predetermined number of tickets drawn correspond to at least one winner of the item.

11. The apparatus of claim 10, wherein the venue comprises an internet website.

12. The apparatus of claim 11, wherein the venue is operatively coupled to at least one database.
